(19) United States
(12) Patent Application Publication
(10) Pub. No.: US 2004/0161104 A1
(43) Pub. Date: Aug. 19, 2004

(54) Disposable sanitary cover for audio mouthpieces and receivers

(76) Inventors: Marc J. DeMichele, Naples, FL (US); Richard B. Mays, Naples, FL (US); Christopher D. Stockton, Naples, FL (US); Henry P. Young, Encinitas, CA (US)

Correspondence Address: EDWARD M. LIVINGSTON, P.A., 963 Trail Terrace Drive, Naples, FL, 34103, US

(21) Appl. No.: 10/368,714

(22) Filed: Feb. 18, 2003

(51) Int. Cl. H04M 1/00

(52) U.S. Cl. 379/451; 379/441

(57) ABSTRACT

A sanitary cover (1, 10, 20, 27) for audio mouthpieces (7,16, 26) or earpieces of headsets, microphones, telephones and so forth to help prevent the spread of germs and other contamination. The cover is made of flexibly elastomeric fabric material having a body (2, 11, 21) with a closed end (4, 13, 23) and an open end (3,12, 22) sized and shaped to fit over a particular mouthpiece. The cover may have an elastomeric collar (14, 24) around the opening to better secure it to a mouthpiece.

### BACKGROUND OF THE INVENTION

This inventions relates to sanitary covers and, more particularly, an acoustically transparent, germ-impermeable cover for audio mouthpieces and receivers, such as headsets, microphones and telephones.

Speaking devices such as microphones, hands-free telephone headsets and handsets are used by many different people, whether it be at their home or at the office. As a result, the audio mouthpieces and earpieces of such devices collect germs, cold viruses and other contamination which spread to many users. Some users attempt to eliminate such contamination by spraying the contact pieces with a disinfectant, such as Lysol®. However, spraying such pieces with a disinfectant can get into the components and cause damage which will limit the usefulness of life of the device.

Also, under normal working conditions the sensitive electronic components of audio mouth and earpieces are exposed to ambient conditions, such as moisture from the mouth, spilled fluids, etc.

Thus, a need exists for a device that will limit the spread of contamination and protects the mouth and earpieces of the audio devices.

The prior art includes the following patents:

| Patent No.: | Inventor: | Issue Date: |
|---|---|---|
| 5,545,859 | Ullrich | Aug. 13, 1996 |
| Des. 371,136 | Horowitz | Jun. 25, 1996 |
| 5,862,215 | Garriette | Jan. 19, 1999 |
| Des. 434,756 | Jackman | Dec. 05, 2000 |
| 2,572,607 | Gruaz | Oct. 29, 1984 |
| Des. 430,561 | McNair | Sep. 05, 2000 |
| 3,243,527 | Sternheim | Mar. 29, 1966 |
| 6,314,185 B1 | Lashley | Nov. 06, 2001 |

### SUMMARY OF THE INVENTION

The objects of the present invention are to provide a mouthpiece and earpieces for an audio device that:

limits the spread of bacteria, virus or other contamination;

protects sensitive electronic components from damage;

is audio transparent so that it does not interfere with voice transmission;

fits a variety of mouthpieces and earpieces;

can be placed over mouthpieces and earpieces without causing contamination of the cover by user's hands;

is disposable;

is easy to use; and

is inexpensive.

The present invention fulfills the above and other objects by providing a cover, having a body surrounded by an opening, cover being cut in the proper size and shape to enclose at least a portion of the mouthpiece or earpiece. The cover is preferably made of fabric material is flexible or elastomeric so that it stretches to enclose a range of sizes and shapes of mouthpieces and earpieces. The fabric material used would preferably be an elastomeric polymer, such as spun lace with a repellent finish, such a material is audio transparent and substantially germ impermeable. The cover may have an elastomeric collar on its circumference of the opening to hold the cover more securely over the mouthpiece or earpiece. Further, the cover may have a pair of oppositely disposed tabs on a perimeter of the cover so the cover can be pulled over a mouthpiece or earpiece without having to touch the outside of the cover, thereby preventing contamination. The shape of the cover may be tubular so that it fits over an elongated mouthpiece with a telephone headset, balloon-shaped to cover a microphone, or circular-shaped to fit around the mouthpiece or earpiece of a telephone handset. The cover may come in a variety of colors as desired of the user.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a tubular-shaped sanitary cover of the present invention for an elongated mouthpiece of telephone headset.

FIG. 2 is an end view from the open end of the cover of FIG. 1; FIG. 3 is a perspective view if the cover of FIG. 1 being placed on mouthpiece;

FIG. 4 is a side view of a bulb-shaped cover for a microphone mouthpiece;

FIG. 5 is an end view of the cover of FIG. 4;

FIG. 6 is a perspective view of the cover of FIG. 4 being placed on a telephone headset;

FIG. 7 is a side view of a circular cover for a telephone mouthpiece or earpiece;

FIG. 8 is an end view of the cover of FIG. 7 for a telephone mouthpiece or earpiece;

FIG. 9 is a perspective view of the cover of FIG. 7 being placed on a telephone mouthpiece or earpiece;

### DESCRIPTION OF THE PREFERRED EMBODIMENTS

For purposes of describing the preferred embodiment, the terminology used in reference to the numbered components in the drawings is as follows:

| | |
|---|---|
| 1. | Elongated tubular cover |
| 2. | Body of cover |
| 3. | Open end |
| 4. | Closed end |
| 5. | Perimeter |
| 6. | Telephone headset |
| 7. | Mouthpiece |
| 8. | User |
| 10. | Bulbular cover |
| 11. | Body |
| 12. | Open end |
| 13. | Closed end |
| 14. | Elastomeric collar |
| 15. | Headset |
| 16. | Microphone mouthpiece |
| 17. | User |
| 20. | Circular cover |
| 21. | Body |
| 22. | Open end |
| 23. | Closed end |
| 24. | Elastomeric collar |
| 25. | Telephone handset |
| 26. | Telephone mouthpiece |
| 27. | Earpiece cover |
| 28. | Pull tabs |

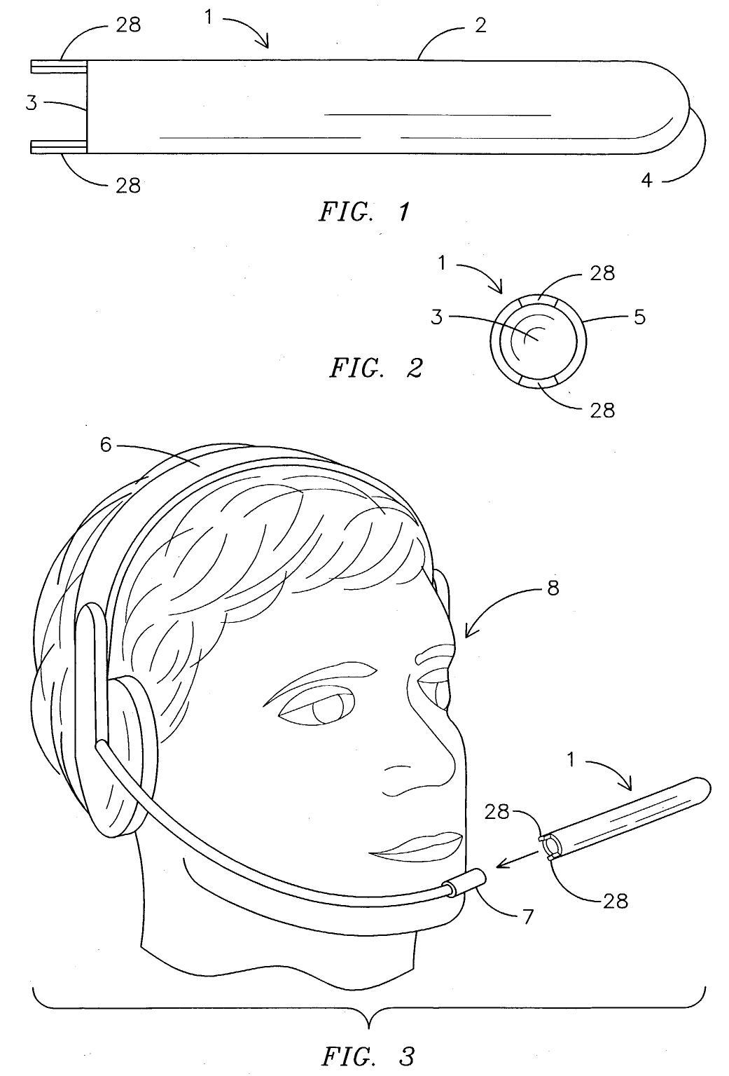

Referring to the drawings, FIGS. 1-3 shows the sanitary cover 1in a tubular configuration to cover the mouthpiece 7 of a telephone headset 6. The tubular cover 1 has an elongated body 2, a closed end 4 and an open end 3 with a perimeter 5. FIG. 3 shows the tubular cover 1 being placed in the direction of the arrow over the mouthpiece 7 of a telephone headset 6 when worn by a user 8. A pair of pull tabs 28 oppositely disposed on the perimeters enable the cover 1 to be pulled over the mouthpiece 7 using one's fingers and without having to contact the body 2, thereby keeping the cover in a sanitary condition.

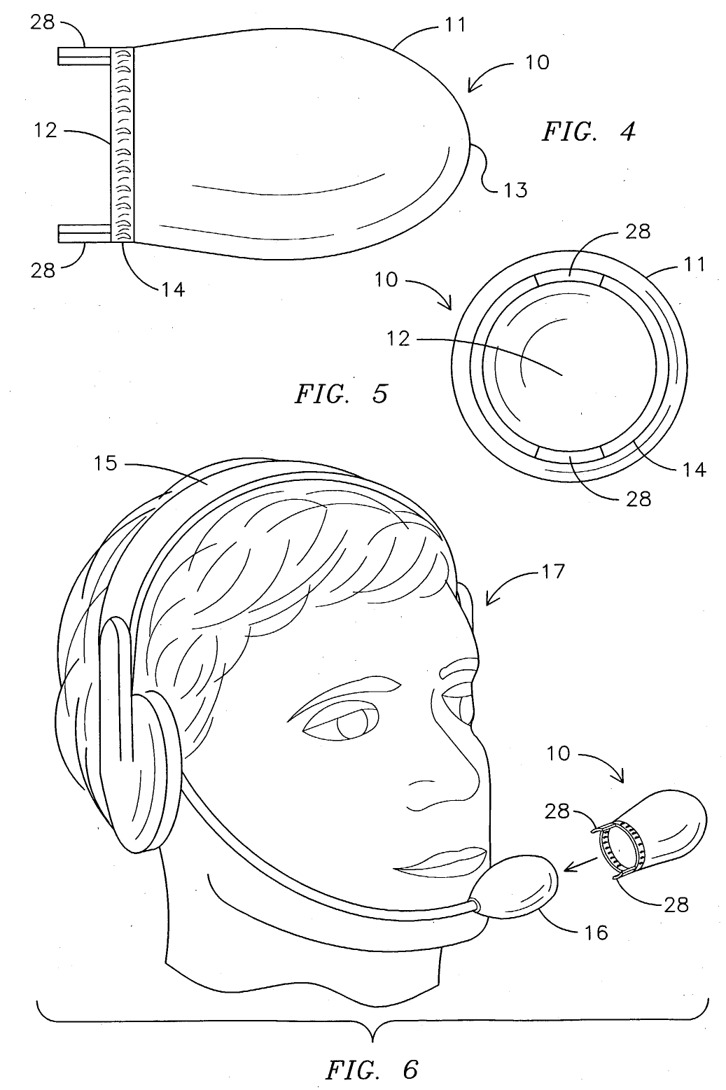

FIGS. 4-6 show a bulb-shaped cover 10 for use in covering a microphone 16. The cover 10 has a balloon-like body 11 with a closed end 13 and an open end 12. The open end12 would preferably have an elastic collar 14 around the opening 12 in order to hold it more securely around a microphone mouthpiece 16. As shown in FIG. 6, the cover 10 is placed in the direction of the arrow over the microphone mouthpiece 16 of a telephone headset 15. The bulb-shaped cover 10 would likely be used in broadcasting.

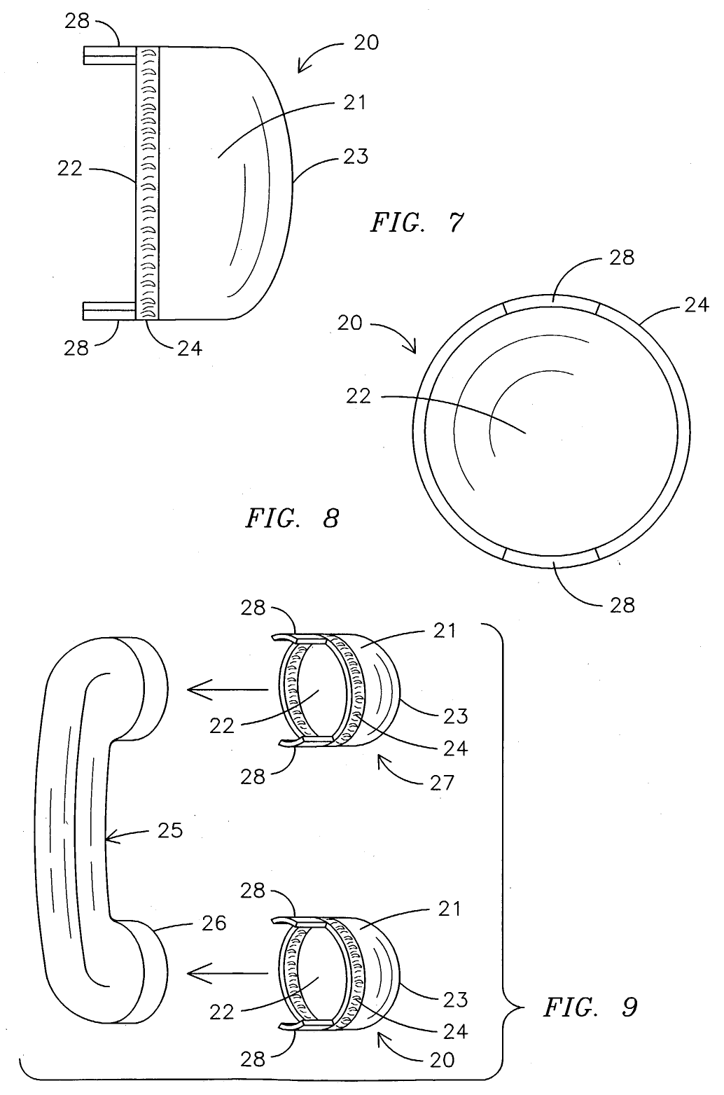

A further embodiment of the present invention for use with telephone handsets 25 is illustrated in FIGS. 7, and 9. The circular cover20 would have a closed end 23, an open end 22 and a body 21. The open end 22 would preferably have an elastomeric collar 24 to more securely hold it around the mouthpiece or earpiece of a telephone handset or other audio transmitter or receiver. As shown inFIG. 9, the cover 20 would be placed in the direction of the arrows over the mouthpiece 26 or as an earpiece cover 27. Thus, the sanitary cover of the present invention could be used not only to cover an audio mouthpieces but also earpieces as well. As with all covers, pull tabs 28 are provided to enable the covers to be pulled over the mouthpieces and earpieces without touching the body of the covers.

The cover would preferably be made of a fabric material that is flexible and slightly elastomeric so that it would fit a variety of sizes of mouthpieces. The preferable fabric material would be a polymer, such as spun lace with a repellent finish. The cover could be made in a variety of colors depending on the aesthetic desires of the user. Although the cover would be inexpensive enough to be disposable, it could be washed and reused if desired.

Although a few preferred embodiments of the present invention have been described in detail hereinabove, all improvements and modifications to this invention within the scope or equivalents of the claims are included as part of this invention.

Having thus described my invention, we claim:

1. A sanitary device for covering audio speaking and receiving pieces comprising:
a cover made of fabric material having an enclosed body surrounding an opening, said cover being cut in the proper size and shape to enclose at least a portion of the audio mouthpiece, said fabric material having substantially germ-impermeable, acoustically-transparent properties.

2. The sanitary device of claim 1 wherein the fabric material is flexible so that it stretches to enclose a wide range of sizes and shapes of pieces.

3. The sanitary device of claim 1 wherein the cover has an elastomeric collar around a perimeter of the opening to hold the cover securely over the pieces.

4. The sanitary device of claim 2 wherein the cover has an elastomeric collar around a perimeter of the opening to hold the cover securely over the pieces.

5. The sanitary device of claim 1 wherein the cover is on a telephone headset.

6. The sanitary device of claim 2 wherein the cover is on a telephone headset.

7. The sanitary device of claim 3 wherein the cover is on a telephone headset.

8. The sanitary device of claim 4 wherein the cover is on a telephone headset.

9. The sanitary device of claim 1 wherein the cover is on a telephone handset.

10. The sanitary device of claim 2 wherein the cover is on a telephone handset.

11. The sanitary device of claim 3 wherein the cover is on a telephone handset.

12. The sanitary device of claim 4 wherein the cover is on a telephone handset.

13. The sanitary device of claim 1 wherein the cover is on a microphone.

14. The sanitary device of claim 2 wherein the cover is on a microphone.

15. The sanitary device of claim 3 wherein the cover is on a microphone.

16. The sanitary device of claim 4 wherein the cover is on a microphone.

17. The sanitary device of claim 1 wherein the fabric material is a polymer lace with a repellent finish.

18. The sanitary device of claim 2 wherein the fabric material is a polymer lace with a repellent finish.

19. The sanitary device of claim 3 wherein the fabric material is a polymer lace with a repellent finish.

20. The sanitary device of claim 1 wherein the shape of the cover is tubular so that it fits over an elongated mouthpiece of a telephone headset.

21. The sanitary device of claim 2 wherein the shape of the cover is tubular so that it fits over an elongated mouthpiece of a telephone headset.

22. The sanitary device of claim 1 wherein the shape of the cover is balloon-like to fit over a bulb-shaped microphone mouthpiece of a headset.

23. The sanitary device of claim 2 wherein the shape of the cover is balloon-like to fit over a microphone mouthpiece of a headset.

24. The sanitary device of claim 3 wherein the shape of the cover is balloon-like to fit over a microphone mouthpiece of a headset.

25. The sanitary device of claim 4 wherein the shape of the cover is balloon-like to fit over a microphone mouthpiece of a headset.

26. The sanitary device of claim 1 wherein the shape of the cover is substantially circular to fit over a mouthpiece of a telephone handset.

27. The sanitary device of claim 2 wherein the shape of the cover is substantially circular to fit over a mouthpiece of a telephone handset.

28. The sanitary device of claim 3 wherein the shape of the cover is substantially circular to fit over a mouthpiece of a telephone handset.

29. The sanitary device of claim 4 wherein the shape of the cover is substantially circular to fit over a mouthpiece of a telephone handset.

30. The sanitary device of claim 1 wherein the shape of the cover is substantially circular to fit over a receiving earpiece of an audio device.

31. The sanitary device of claim 1 further comprising a pair of tabs oppositely disposed on a perimeter of the opening so the cover can be pulled over the audio speaking and receiving piece without having to touch an outside of the cover.

32. The sanitary device of claim 2 further comprising a pair of tabs oppositely disposed on a perimeter of the opening so the cover can be pulled over the audio speaking and receiving piece without having to touch an outside of the cover.

33. The sanitary device of claim 3 further comprising a pair of tabs oppositely disposed on a perimeter of the opening so the cover can be pulled over the audio speaking and receiving piece without having to touch the outside of the cover.

34. The sanitary device of claim 4 further comprising a pair of tabs oppositely disposed on a perimeter of the opening so the cover can be pulled over the audio speaking and receiving piece without having to touch the outside of the cover.

35. The sanitary device of claim 5 further comprising a pair of tabs oppositely disposed on a perimeter of the opening so the cover can be pulled over the audio speaking and receiving piece without having to touch the outside of the cover.

36. The sanitary device of claim 6 further comprising a pair of tabs oppositely disposed on a perimeter of the opening so the cover can be pulled over the audio speaking and receiving piece without having to touch the outside of the cover.

37. The sanitary device of claim 7 further comprising a pair of tabs oppositely disposed on a perimeter of the opening so the cover can be pulled over the audio speaking and receiving piece without having to touch the outside of the cover.

38. The sanitary device of claim 8 further comprising a pair of tabs oppositely disposed on a perimeter of the opening so the cover can be pulled over the audio speaking and receiving piece without having to touch the outside of the cover.

39. The sanitary device of claim 9 further comprising a pair of tabs oppositely disposed on a perimeter of the opening so the cover can be pulled over the audio speaking and receiving piece without having to touch the outside of the cover.

40. The sanitary device of claim 10 further comprising a pair of tabs oppositely disposed on a perimeter of the opening so the cover can be pulled over the audio speaking and receiving piece without having to touch the outside of the cover.

41. The sanitary device of claim 11 further comprising a pair of tabs oppositely disposed on a perimeter of the opening so the cover can be pulled over the audio speaking and receiving piece without having to touch the outside of the cover.

42. The sanitary device of claim 12 further comprising a pair of tabs oppositely disposed on a perimeter of the opening so the cover can be pulled over the audio speaking and receiving piece without having to touch the outside of the cover.

43. The sanitary device of claim 13 further comprising a pair of tabs oppositely disposed on a perimeter of the opening so the cover can be pulled over the audio speaking and receiving piece without having to touch the outside of the cover.

44. The sanitary device of claim 14 further comprising a pair of tabs oppositely disposed on a perimeter of the opening so the cover can be pulled over the audio speaking and receiving piece without having to touch the outside of the cover.

45. The sanitary device of claim 15 further comprising a pair of tabs oppositely disposed on a perimeter of the opening so the cover can be pulled over the audio speaking and receiving piece without having to touch the outside of the cover.

46. The sanitary device of claim 16 further comprising a pair of tabs oppositely disposed on a perimeter of the opening so the cover can be pulled over the audio speaking and receiving piece without having to touch the outside of the cover.

47. The sanitary device of claim 17 further comprising a pair of tabs oppositely disposed on a perimeter of the opening so the cover can be pulled over the audio speaking and receiving piece without having to touch the outside of the cover.

48. The sanitary device of claim 18 further comprising a pair of tabs oppositely disposed on a perimeter of the opening so the cover can be pulled over the audio speaking and receiving piece without having to touch the outside of the cover.

49. The sanitary device of claim 19 further comprising a pair of tabs oppositely disposed on a perimeter of the opening so the cover can be pulled over the audio speaking and receiving piece without having to touch the outside of the cover.

50. The sanitary device of claim 20 further comprising a pair of tabs oppositely disposed on a perimeter of the opening so the cover can be pulled over the audio speaking and receiving piece without having to touch the outside of the cover.

51. The sanitary device of claim 21 further comprising a pair of tabs oppositely disposed on a perimeter of the opening so the cover can be pulled over the audio speaking and receiving piece without having to touch the outside of the cover.

52. The sanitary device of claim 22 further comprising a pair of tabs oppositely disposed on a perimeter of the opening so the cover can be pulled over the audio speaking and receiving piece without having to touch the outside of the cover.

53. The sanitary device of claim 23 further comprising a pair of tabs oppositely disposed on a perimeter of the opening so the cover can be pulled over the audio speaking and receiving piece without having to touch the outside of the cover.

54. The sanitary device of claim 24 further comprising a pair of tabs oppositely disposed on a perimeter of the opening so the cover can be pulled over the audio speaking and receiving piece without having to touch the outside of the cover.

55. The sanitary device of claim 25 further comprising a pair of tabs oppositely disposed on a perimeter of the opening so the cover can be pulled over the audio speaking and receiving piece without having to touch the outside of the cover.

56. The sanitary device of claim 26 further comprising a pair of tabs oppositely disposed on a perimeter of the opening so the cover can be pulled over the audio speaking and receiving piece without having to touch the outside of the cover.

57. The sanitary device of claim 27 further comprising a pair of tabs oppositely disposed on a perimeter of the opening so the cover can be pulled over the audio speaking and receiving piece without having to touch the outside of the cover.

58. The sanitary device of claim 28 further comprising a pair of tabs oppositely disposed on a perimeter of the opening so the cover can be pulled over the audio speaking and receiving piece without having to touch the outside of the cover.

59. The sanitary device of claim 29 further comprising a pair of tabs oppositely disposed on a perimeter of the opening so the cover can be pulled over the audio speaking and receiving piece without having to touch the outside of the cover.

60. The sanitary device of claim 30 further comprising a pair of tabs oppositely disposed on a perimeter of the opening so the cover can be pulled over the audio speaking and receiving piece without having to touch the outside of the cover.
